(19) United States
(12) Patent Application Publication
(10) Pub. No.: US 2011/0040645 A1
(43) Pub. Date: Feb. 17, 2011

(54) VIRTUAL WORLD INTEGRATED AUCTION

(76) Inventors: Nancy J. Rabenold, Brandon, FL (US); James A. Simmons, Brandon, FL (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/541,762

(22) Filed: Aug. 14, 2009

(51) Int. Cl. G06Q 30/00; G06F 3/01

(52) U.S. Cl. 705/26.3; 715/751

(57) ABSTRACT

An auctioning environment integrated into a virtual world system includes a computing platform that provides a virtual world environment and the integrated auctioning element. The system interfaces to a third party system to receive auctioning data representative of an auction that is taking place in the real world and in real time. The auctioning data is then used to formulate or augment a user interface for presenting an environment to a user of the virtual world system to participate in the auction. The environment can be presented in a variety of manners and in one embodiment includes an avatar for the auctioneer, the item being auctioned and any bidders present and participating at the live auction event.

### CROSS-REFERENCE TO RELATED PATENTS

This application is related to a United States patent application that has a title of GAMING INTERFACE TO ONLINE AUCTION, identified by Attorney Docket Number 01004.1120, which was filed concurrently with this application, and U.S. Pat. No. 6,813,612, both of which are hereby incorporated by reference in their entirety.

### BACKGROUND

The convergence of technologies is rather rampart in the world. Computers, personal data devices, pagers, cellular telephones, Internet browsers have all been conveniently merged into a pocket sized product and marketed under the names of BLACKBERRY, IPHONE and the like. Other convergences are also being realized today. Once such conversion is the combination of virtual reality with the Internet. It wasn't that long ago that one had to drive to the local DAVE AND BUSTERS, or similar arcade, and stand in line behind a slew of teenagers to have the privilege of paying five dollars for the 60 second thrill associated with engaging a virtual reality system to combat components, shoot down space aliens, or play a couple holes of golf.

Today, however, many can enjoy the excitement of participating in a virtual reality system in the comfort of their own home. One such virtual reality and Internet convergence system that is gaining significant popularity in the market is the PLAYSTATION HOME or HOME marketed by SONY.

HOME has been described as a community-based service that runs on the PlayStation 3 platform and integrates, via the Internet, to the PlayStation Network. HOME has been in development since early 2005 and started beta test open to the public in December 2008. HOME allows users to create an avatar on their PlayStation 3 console and explore an online, virtual world. A HOME user's avatar gets its own virtual apartment space, or “HomeSpace,” which can be adorned with items that users can obtain in several different ways.

Upon entering HOME, users are greeted with the Message of the Day, which contains administrative information such as upcoming updates, events, and event winners. The Message of the Day is updated frequently. Also, users get an avatar and invitation-only virtual apartments which they can personalize with their own choice of decor and furnishings. Additionally, users have several ways to interact with the HOME environment, as well as other HOME users.

A HOME user can create a uniquely personal avatar or, in the alternative, select one of several preset avatars available in HOME. To outfit a selected avatar, users can access the “Wardrobe” from the Menu Pad at any time and location. Further, users may customize a variety of an avatar's physical features including gender, skin tone, hair, body shape and facial structure. Users may also customize an avatar's clothing and accessories using either a set of standard items, or items bought from one of the virtual clothing shops in HOME. Notably, a user has the ability to save up to nine versions of their avatar for quick access at any time.

As mentioned prior, each HOME user is associated with a virtual, private apartment space, called a “Personal Space,” which can be modified and changed any time the user, via an avatar, is in it. The initial basic apartment, termed the “Harbour Studio” because it overlooks a virtual harbour, is free and offers users limited options for customization and personalization. In the future, it is expected that SONY will provide tools that will enable users to have an even greater ability to create their own Personal Spaces and content. Notably, users may invite any other HOME user (even cross-region) to their Personal Space and, in time, will be able to stream the host's music from their console's hard drive. Further, videos may be accessible for viewing and users may also be able to place their own digital photographs in frames to display on the wall of their virtual apartment. For now, while the Harbour Studio and basic furniture is provided to all users free of charge, premium Personal Spaces (such as a “Summer House”) and other furniture is available to purchase from the shopping complex.

Users are able to purchase Clubs. Each club has a leader (the user who purchased the club) who can elect up to 4 sub-leaders and can have up to 32 members in total. In a similar way to Personal Spaces, a club's owner is able to set-up and decorate a private clubhouse as a meeting point for club members. The clubhouse also features a notice board where the leader and sub-leaders can post messages and announcements to other members.

In addition, HOME may include a “Hall of Fame” which will include “Trophy Rooms.” A Trophy Room is a Personal Space where users are able to display 3D representations of their PlayStation Network Trophies.

HOME has no on-screen User Interface (UI) (or HUD); however, all of HOME's features are available from the controller. The options are: Quick Chat, a Gestures menu, the Menu Pad, the Safe Screen, and in-game XMB.

The Menu Pad, which is accessible by pressing Start, controls a user's avatar appearance by changing the Wardrobe, decorations, travel destinations (with the World Map), settings, and other main options. The Menu Pad is shown in the user's hands when in use and has eleven options including a Help menu for beginners. The Menu Pad features an inventory, which currently only has the “Bubble machine.” In time, Home Stuff in the shopping complex will have inventory items for purchase, which the user can purchase at any time.

The Safe Screen is used for reporting, changing communication settings, and quick access to the user's Personal Space and XMB friends list. Such is accessed with the Select button.

Users communicate in a variety of ways in HOME. For instance, users are able to write text messages to each other using either a USB or Bluetooth keyboard or with a PS3 controller using the on-screen keyboard. These messages appear in speech bubbles over an avatar's head and in the chat log. Voice chat, with the use of a USB or Bluetooth headset can also be utilized to communicate with others in the personal spaces or by making a telephone call to a specific user. The user can also perform gestures (or “e-motes”) via an avatar such as waving, nodding or dancing. A quick chat feature is also available. A library of short, predetermined phrases (such as “Hello” and “Where are you from?”) can be accessed using a quick access menu.

Although the HOME service itself can be used free of charge, premium content is available for purchase from various stores in the virtual shopping complex. Users browse and pay for items, such as virtual clothing and furniture, by accessing a shop and using it's PlayStation Store interface. Items are paid for in real currency using funds from the user's PlayStation Network Wallet. Alongside content designed by SONY, real-world companies are also able to sell virtual goods through their own stores in HOME. For example, Diesel and Ligne Roset are both represented in HOME with their own stores where users can purchase virtual items based on the companies' own clothing designs.

Not surprisingly, advertising is prominent in HOME's public spaces. Currently, the advertising is primarily PlayStation focused, although other video gaming-related brands are also represented. SONY currently streams most advertising from its HOME servers and targets the content to specific regional audiences, although the capability certainly exists to target particular HOME users.

The Home Square (Europe, Asia, and Japan) or Central Plaza (North America) is where users commonly meet and chat. Predictably, it is these virtual spaces in HOME where much of the advertising occurs, and it connects all the main locations in HOME together. Currently, it has a few video screens, advertising posters (unavailable in Central Plaza), and region-specific features (such as Listen@Home for North America). Listen@Home is a listening post in the Central Plaza where users gather to listen to music. There are currently nine songs for which users may cast a vote and listen. Also in the Central Plaza, there is a pond-like feature with Saucer Pop (a game where users fly saucers around and collect stars and fuel while avoiding exploding canisters). The European Home Square has a place to play chess and draughts/checkers. The Asian and Japanese Home Square has a dock, behind the Game Space, from which users can look out into an ocean and view cities on islands.

The HOME Theatre (available in all regions) is a virtual cinema where users can view a range of video content. This content includes film and game trailers and video game features from third-party publishers such as Eurogamer. Videos are displayed in the 3D environment on virtual video screens which can be viewed full screen on a user's monitor. Users can walk around the cinema that they're in except in the European Home. In contrast to the trailers available on the PlayStation Store, the dynamic video content in HOME is presented in standard definition. Each region has very different Home Theatres.

At the Bowling Alley (Europe & North America) or the Game Space (Asia & Japan), social mini-games such as 10-pin bowling and billiards can be played as well as a variety of arcade-machine games such as Echochrome, Icebreaker, and Carriage Return. Prizes are awarded for beating the arcade-machine games, such as an Echochrome suit for a user's avatar. Users who have downloaded the Namco Museum beta from the Asian or Japanese PlayStation Store are able to unlock additional arcade games including Pac-Man, Dig Dug, Galaga, and Xevious. Users with the Namco Museum beta on their PS3 can win the prizes for the corresponding account on which it is played. However, users can only play them at the Game Space, and not the Bowling Alley. Currently, there are pool tables, bowling lanes, arcade machines, video screens, and dart boards (only in Game Space).

The Shopping Centre (Europe), Mall (North America), or Shopping Mall (Asia & Japan), all formerly termed Marketplace for all regions, is where all purchases are made to buy new clothes, accessories, premium locations (such as new Personal Spaces), and other items. Purchases require the user's real, local currency and it works in a manner similar to the PlayStation Store. Currently, there are stores, one video screen, advertising posters, and a place to play chess (unavailable in the Shopping Mall). The current stores consist of Home Stuff, Home Estates, Home Threads, a Home furniture store, Ligne Roset furniture, and Diesel clothes. The latter two are unavailable in the Shopping Mall. Further, there are currently no items available for purchase from Home Stuff. In time, Home Stuff will have items that go into a user's inventory, such as the Bubble Machine.

Home Café (Asia & Japan only) is another place for users to meet up and chat. There is currently only seating in the café and it is two-stories. In time, the café will become an event space (according to the location description). Japan's Café includes a statue of the mascot of Famitsu Game Magazine, a video screen, and the second floor has a display of a messy office.

Sony Computer Entertainment has also created Game Spaces for Uncharted, Drake's Fortune and Siren, Blood Curse and another for LittleBigPlanet which is currently in development. Game Spaces vary depending on region.

Video game developers are able to create Developer Spaces and their own Game Spaces to showcase their products in HOME. Other, non-gaming-related companies can also create sponsored Company Spaces for HOME. In time, users may be able to make content for HOME, but likely with strict moderation.

The HOME virtual environment provides a forum for many types of events. In time, more events will occur, such as exclusive game previews and developer interviews. Each event is organized by HOME and its affiliated content providers. Live events, such as sports and concerts, may also be broadcast within HOME. Further, it is conceivable that premium events may well use the PlayStation Network Wallet.

Several events that have taken place in HOME require the users to either answer questions or suggest ideas on the Official PlayStation Home Forums for a chance to win a prize. A couple of these events are the 12 Games of Christmas (annual event in North America), a question and answer event, and Name the New Home Space which determined the name of the new North American Home Space known as the Home Café in Asia and Japan. The prize is generally a $10 (US) product voucher for virtual items in the shopping complex. These events are organized by the PlayStation Home Managers.

SONY states that behavior of users in HOME is strictly monitored. A variety of potentially offensive words and word combinations are automatically censored in messages that users write to each other and administrators are able to block a users' individual console and IP address from accessing the service if a user behaves illegally, inappropriately or other than in accordance with the terms of use of the service. Users are also able to report inappropriate or offensive behavior of other users to moderators by accessing the PlayStation Home Safe Screen. Additionally, users can change their personal communication settings to block messages from other users who are not on a predetermined friends list.

Auction Management Solutions of Tampa, Fla. is the industry leader in the development and deployment of on-line auctioning, including the integration of online and live, at the auction bidders for participation in a single, real time auction event. The technology available from Auction Management Solutions is more fully described in the text of U.S. Pat. No. 6,813,612 which is incorporated herein by reference.

With the capabilities available through the SONY HOME product, there is a need in the art for a system that integrates or converges the Auction Management Solutions on-line auctioning technology with the SONY HOME technology or similar, virtual-world or virtual-reality and Internet converged systems.

### BRIEF SUMMARY

Various embodiments of an auctioning environment integrated into a virtual world system are presented. One embodiment includes a computing platform that provides a virtual world environment including the integrated auctioning element. In operation, the system interfaces to a third party system to receive auctioning data representative of an auction that is taking place in the real world and in real time. The auctioning data is then used to formulate or augment a user interface for presenting an environment to a user to participate in the auction. The environment can be presented in a variety of manners and in one embodiment includes an avatar for the auctioneer, the item being auctioned and any bidders present and participating at the live auction event.

If the user elects to bid on an item, the user enters a bid through the user interface environment. In this embodiment, the bid can then be presented within the real world auction by providing the bid through the third party interface. If the user is successful in winning the item, confirmation data is sent to the virtual world through the third party interface. A transaction can then be performed to attribute the item to the user.

In some embodiments, the auctioning environment may be limited to a virtual environment without any connection to a real world live auction. In other embodiments, the real world live auction may simply serve as input into a virtual auction. These and other embodiments will be more fully appreciated in the detailed description and the following figures.

### BRIEF DESCRIPTION OF THE SEVERAL VIEWS OF THE DRAWING

FIG. 1 is a block diagram illustrating an exemplary environment in which various embodiments of the virtual auction space may be incorporated.

FIG. 2 is a general block diagram illustrating a hardware/system environment suitable for various embodiments of the present invention.

FIG. 3 is a flow diagram illustrating the steps in an exemplary embodiment of an integrated virtual auction.

### DETAILED DESCRIPTION OF EMBODIMENTS

The present invention, as well as features and aspects thereof, is directed towards providing an integrated online virtual-reality/world and an online auctioning system. The exact details of such an integrated system can be accomplished in an almost infinite number of ways and the examples being presented herein are only for illustrative purposes and, therefore, do not serve to limit the scope of the invention.

In general embodiments, a space can be created within the virtual-reality system for an auction to reside. It should be appreciated that in some embodiments, the auction may not even exist in or occupy a space in the virtual world. Rather, the users of the virtual world may access and interact with the auction similar to how they participate today—through an interface screen.

Those skilled in the art will appreciate that auctions can be presented in a variety of settings from a couple guys sitting in the back of a pick-up truck that moves up and down through rows of farm equipment as local farmers and the occasional patent attorney bids on the available items, to massive, multilane housed events with auctioneers chanting as vehicles are pushed through the lines in 10 second increments. In all of these settings, the AMS technology has created a manner for individuals to participate in the auctions in an online fashion with the same capabilities, visibilities and advantages of a person actually standing in front of the auctioneer.

One embodiment of the virtual world auctioning system may be created to occupy a publicly accessible space in the virtual world, such as the Mall in HOME. The auction space would allow users to enter by navigating their avatars into the space. The typical embodiment would include an avatar of an auctioneer and any other personnel required to run the auction, such as clerks, yippers, etc. The space may also include computer or system controlled bidders that are not associated with a user.

In such an embodiment, items can be brought up for bid and the users that have entered into the auction space, and/or have been qualified to participate in the auction event, may then begin placing bids on the item. The virtual auctioneer, similar to a real auctioneer in a live auction, plays the audience in an effort to increase the bidding level for the various items. Once the auctioneer yells “sold,” the item is acquired for the user/avatar.

In other embodiments, a separate space can be set up for the auction events that are not included in standard available spaces, such as the Mall in HOME. In such embodiments, the space may be set up similar to what the space in a comparable live auction would be set up.

Some embodiments of the virtual auction may be 100% virtual in nature, i.e. the items that are being auctioned off, similar to the produces available by Diesel and Ligne Roset in HOME, are simply virtual items that exist only in the virtual world. Moreover, in such an embodiment, the auction event only exists in the virtual world.

In other embodiments, the auction being presented in the virtual world may actually be a virtual representation of a live auction actually taking place in the real world. In such an embodiment, the participants in the virtual auction would be akin to the online bidders in the Auction Management Solutions' auctioning technology (referred to in the market as ONLINE RINGMAN). The actions of the auctioneer avatar would mimic those of the live auctioneer. Avatars in the virtual auction space would be created to mimic the actual live bidders at the auction event. The actual, real items up for auction would be presented as avatars in the virtual auction. In such an embodiment, the users participating in the auction event would be qualified and approved to participate in the auction and would actually be bidding real dollars for real items.

Other embodiments of the virtual auction space may be a blend, at various levels of degree of the two above-presented embodiments. For instance, in one embodiment, the virtual auction space may take on the form of the virtual presentation of a real-world live auction but, in addition to the winning bidder acquiring the real property, if the winning bidder is in the virtual space, he or she would also obtain a virtual representation of the item won that can then exist in the user's virtual space.

In another embodiment of the virtual auction space, the virtual presentation of a real-world live auction may be presented but, the participants in the virtual world would only be bidding with virtual money and not actually acquire the real-world item but rather, simply a virtual representation of the real world item. In such an embodiment, the virtual auction space would mimic the actions in the live auction but deviate there from by the virtual bids only existing in the virtual auction space and not being fed back into the live, real-world auction. Thus, the virtual auction space would include additional intelligence to allow the bidding and auctioning activity to feed into the virtual auction space but, bidding participation from the virtual bidders would be algorithmically integrated and blended with the live feed to allow the virtual participants to outbid and win the auction.

In another embodiment of the present invention, the virtual auction space may represent an interface to a real-world live auction but, the virtual participants would be bidding with a virtual currency. For instance, in the virtual world, users may accumulate virtual money in a variety of settings. A few non-limiting examples may include gaining points for watching various advertisements, spending certain amount of time in the virtual world, receiving bonuses for winning games, participating in surveys, or any of a wide variety of other situations. This virtual currency, although not being able to be redeemed for real cash, could be used by the virtual participants in a real-world auction to acquire actual, real-world products.

In another embodiment, other store front participants or entities in the virtual world may also auction off their items in the virtual auction space. For instance, in the HOME environment, a user can virtually purchase clothing from the Diesel store front. In this embodiment, Diesel may offer their products in the virtual auction space for users to bid on and acquire virtually. In addition, Diesel, or any other merchant may offer the products in a blended fashion in virtual auction space by not only allowing the virtual participants to acquire the product virtually but also, to acquire real-world counterparts. For instance, in one embodiment, a merchant may auction an item. The winning bidder may obtain a virtual representation of the product and then receive a gift card to allow them to go to a brick and mortar store to obtain a physical version of the product. Likewise, the merchant can simply drop ship a physical version of the product to the winning bidder.

In another embodiment, users in the virtual world may auction off their own virtual or real assets. For instance, a virtual user may create a virtual asset, such as a special avatar to represent himself or herself, items to be included in the user's space, features to be incorporated onto the user's avatar (such as a hat, a T-shirt, etc.). The user can then auction off the item to other virtual users. In this embodiment, the virtual user would assume the role of the auctioneer. The virtual user may post an upcoming auctioning event and invite other users and/or allow other users to request participation. The currency in such an auction may be virtual. In such an embodiment, the virtual currency of the winning bidder would then be transferred to the auctioneer or, to a destination indicated by the auctioneer. The currency in such an embodiment may also be real currency. In such an embodiment, a system such as PAYPAL could be used to complete the sale of the item.

It will also be appreciated that the virtual user could offer his or her item up for auction in an already existing virtual auction space. In this embodiment, the user would submit his or her item to the auction space to be auctioned in turn. Proceeds from the auction, either virtual currency, real currency or both, would then be distributed to the owner of the item with possibly a portion of the proceeds being retained by the entity running the virtual auction space.

It will also be appreciated that the various embodiments of the invention may utilize an EBAY like auction environment rather than a live auction environment.

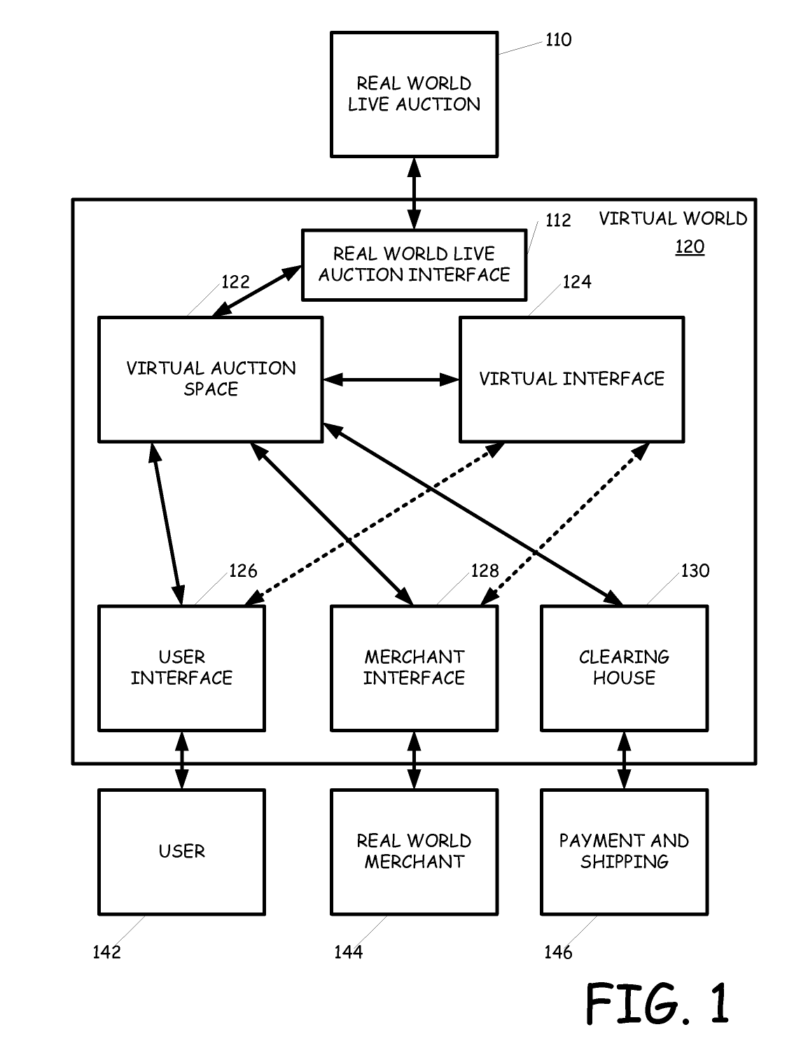

FIG. 1 is a block diagram illustrating an exemplary environment in which various embodiments of the virtual auction space may be incorporated. In the illustrated embodiment, a real world live auction 110 is shown as being interfaced to the virtual world 120 through a real world live auction interface 112. However, as described above, embodiments may be implemented that do not include or incorporate an interface to a real world auction. In the illustrated embodiment, feed from the real world live auction 110 is presented to the virtual world 120. The feed can take on a variety of forms and content. For instance, in one embodiment the feed may include live audio from the auction floor, live video of the auctioneer, the audience, and/or the items being auctioned, a catalog of information pertaining to the items presently being auctioned, to be auctioned and/or that have been auctioned in the past, and/or live bid activity and status (including current bid, requested bid, accepted bids, rejected bids, or the like). Rather than providing video and audio in the feed, avatars and text may be substituted in some embodiments.

The virtual world 120 is shown as including a virtual auction space 122, a virtual interface 124, a user interface 126, a merchant interface 128 and a clearing house 130. Further, the virtual world 120 may also interfaces to a user 142, a real world merchant 144 and a payment and shipping entity 146.

In an illustrative embodiment, content fed from the real world live auction 110 is received by the virtual auction space 122 and processed for presentment to the virtual community or users 142 through the user interface 126. The information can be presented in a variety of formats. As previously described, a virtual auction scenario may include avatars for the auctioneer, the live bidders and/or items being auctioned. In addition, or in the alternative, the virtual auction scenario may include live video or actual photographs for any of the above-listed elements. A variety of other additions, modifications or alternatives may also be used. For instance, items being auctioned may be presented in the virtual auction space in an ITUNES like interface. Such an interface would allow users to easily search for items being auctioned and sample or preview information about the item. Similarly, an EBAY like or ONLINE RINGMAN like interface may also be used.

In some embodiments, real world merchants 144 may present items into the virtual auction space 122 through the merchant interface 128. This would be analogous to individuals or entities entering items into a real world auction space. This aspect of the various embodiments enables a merchant to insert items into the virtual auction. The items may be real items, virtual items or a combination of both. In addition, embodiments may allow merchants to enter items into the virtual auction space 122 that can then be pulled down into the real world live auction. This aspect enables merchants 144 to have an interface for placing items into a virtual auction and/or into a real world auction from a single merchant interface 128.

As previously described, the virtual auctions can be characterized in a variety of manners including but not limited to:
real currency used to purchase real items;
virtual currency used to purchase real items;
real currency used to purchase virtual items; and
virtual currency used to purchase virtual items.

In any of these scenarios, a clearing house 130 may be utilized to finalize the sale, be it virtual or real. In the virtual scenario, the entire transaction can be conducted within the clearing house 130. However, in some virtual transactions, as well as in transactions that include real currency and/or real products, the clearing house 130 may interface with an external system 146 to finalize the transaction. For instance, for a real currency transaction, a system such as PAYPAL may be interfaced to in finalizing the transaction. Further, a shipping entity may be interfaced to in order to identify and ship real items that are purchased or won through the auction.

A virtual interface 124 is also illustrated as interfacing with the virtual auction space 122. The virtual interface 124 may provide a variety of functions. A few non-limiting examples of such functions include the platform (such as HOME) creating virtual items for the user base and presenting them for auction in the virtual auction space 122. The virtual interface 124 may also serve as the interface for the users or merchants to enter real or virtual items into the virtual auction space 122.

It should be appreciated that the various functional blocks presented in FIG. 1 are for illustrative purposes only. Not all embodiments will require all of the various elements and, the included functions do not necessarily have to be separated out in accordance with the various blocks. Indeed, the various functions may be combined or broken out in a variety of arrangements.

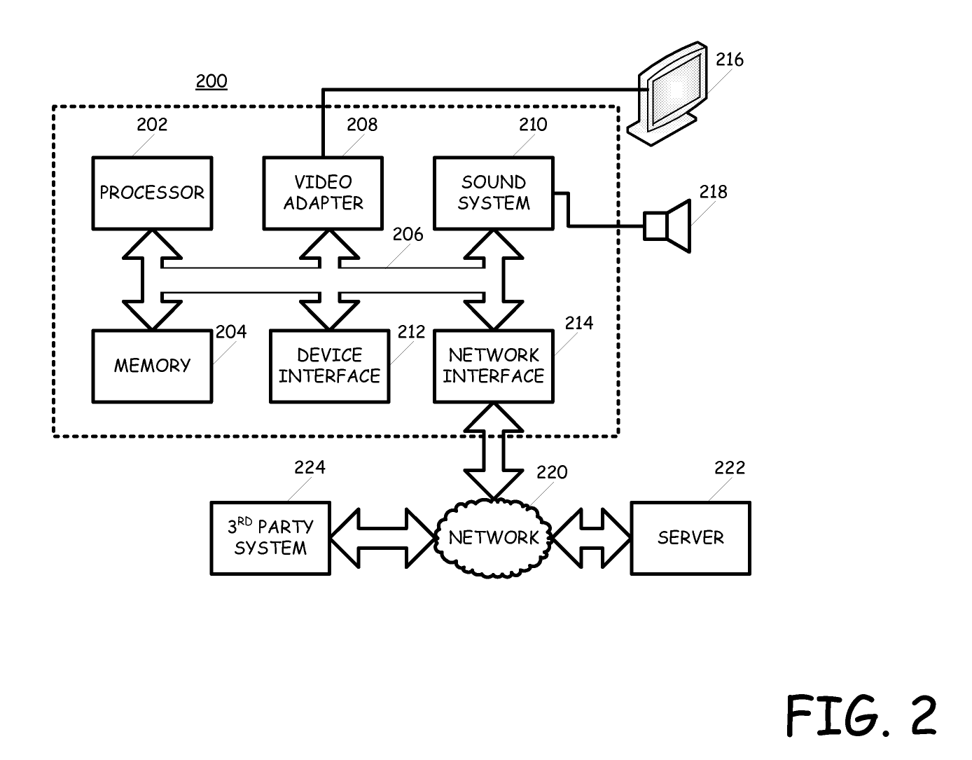

FIG. 2 is a general block diagram illustrating a hardware/system environment suitable for various embodiments of the present invention. A general computing platform 200 is shown as including a processor 202 that interfaces with a memory device 204 over a bus or similar interface 206. The processor 202 can be a variety of processor types including microprocessors, micro-controllers, programmable arrays, custom IC's etc. and may also include single or multiple processors with or without accelerators or the like. The memory element 204 may include a variety of structures, including but not limited to RAM, ROM, magnetic media, optical media, bubble memory, FLASH memory, EPROM, EEPROM, etc. The processor 202 also interfaces to a variety of elements including a video adapter 208, sound system 210, device interface 212 and network interface 214. The video adapter 208 is used to drive a display, monitor or dumb terminal 216. The sound system 210 interfaces to and drives a speaker or speaker system 218. The device interface 212 may interface to a variety of devices (not shown) such as a keyboard, a mouse, a pin pad, and audio activate device, a PS3 or other game controller, as well as a variety of the many other available input and output devices. The network interface 214 is used to interface the computing platform 200 to other devices through a network 220. The network may be a local network, a wide area network, a global network such as the Internet, or any of a variety of other configurations including hybrids, etc. The network interface may be a wired interface or a wireless interface. The computing platform 200 is shown as interfacing to a server 222 and a third party system 224 through the network 220.

The described embodiments of the integrated auctioning system can be deployed in the environment illustrated in FIG. 2. For instance, an integrated auctioning system and HOME may reside on a server 222 (which is structured similar to the computing platform 200) and receive auctioning input from the third party system 224 and be interfaced and participated in by a user operating the computer platform 200—which in such an embodiment would be a PLAYSTATION device.

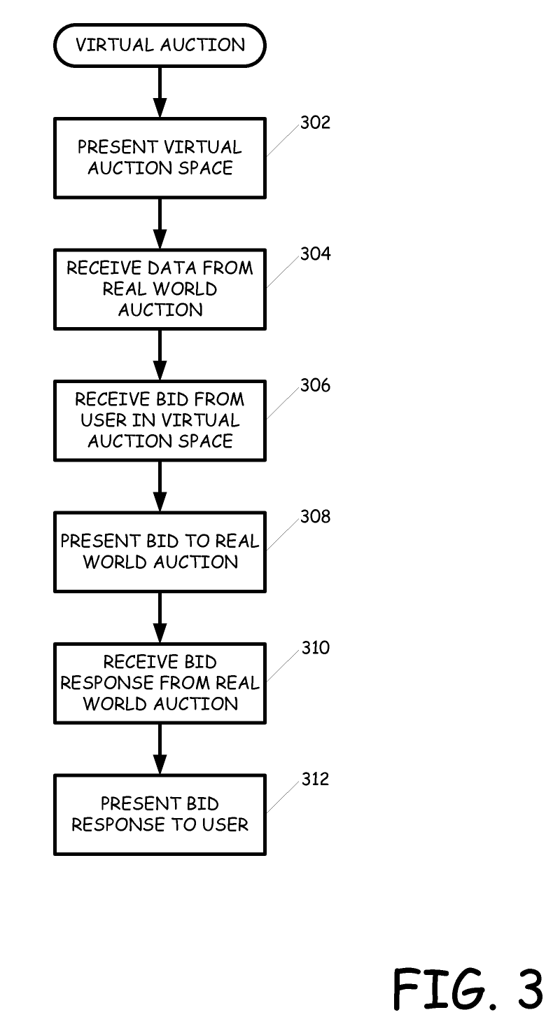

FIG. 3 is a flow diagram illustrating the steps in an exemplary embodiment of an integrated virtual auction. Initially, a virtual auction space is presented within a virtual world 302. A user can interact with the virtual auction space by virtually walking into the auction area or by other techniques. When a real world auction environment is being presented, data from the real world auction is received 304 and then presented within the virtual auction space. A user that is interfacing to the virtual auction space can then place a bid on an item that is presently being auctioned 306. The received bid can then be presented to the real world auction as an entered bid for the item 308. The bid may be accepted, rejected or may result in being the winning bid. The response to the bid is then received from the real world auction environment 310 and is then presented to the bidder, as well as others participating in the real or virtual auctioning event 312.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A computing platform providing a virtual world environment including an auctioning element being integrated into the virtual world environment, the computing platform comprising:
a processor;
a memory device communicatively coupled to the processor;
a third party interface to a real-world live auction for receiving auction data;
a user interface;
a virtual auction space component residing on a memory device and including instructions that when executed by the processor, are operative to:
receive the auction data from the third party interface;
create a visual environment for presentment of the auctioning data to the user interface;
receive a bid from the user interface for an item being auctioned as defined in the auction data;
present the bid to the real world auction through the third party interface;
receive data from the third party interface indicating that the bid from the user interface has been accepted as a winning bid for the item being auctioned; and
finalize a transaction to attribute the item to a user associated with the bid.

2. The computing platform of claim 1, wherein the step of creating a visual environment for presentment of the auctioning data to the user interface further comprises creating at least one avatar within the visual environment.

3. The computing platform of claim 2, wherein an avatar represents the item being auctioned.

4. The computing platform of claim 2, wherein an avatar represents a user of the virtual world environment.

5. The computing platform of claim 2, wherein an avatar represents an attendee of a real-world live auction.

6. The computing platform of claim 1, wherein the step of finalizing a transaction to attribute the item to a user associated with the bid further comprises a monetary transaction.

7. The computing platform of claim 1, wherein the step of finalizing a transaction to attribute the item to a user associated with the bid further comprises presenting said user with a virtual replica of the real-world item.

8. The computing platform of claim 1, wherein the step of finalizing a transaction to attribute the item to a user associated with the bid further comprises the redemption of a voucher.

9. The computing platform of claim 8, wherein the voucher was obtained by the user through previous activity within the virtual world environment.

10. The computing platform of claim 9, wherein the previous activity within the virtual world environment comprised participation in a game.

11. The computing platform of claim 9, wherein the previous activity within the virtual world environment comprised taking a survey.

12. The computing platform of claim 9, wherein the previous activity within the virtual world environment comprised viewing an advertisement.

13. The computing platform of claim 9, wherein the previous activity within the virtual world environment is quantified based on a user's time spent in the virtual world environment.

14. The computing platform of claim 1, wherein the step of finalizing a transaction to attribute the item to a user associated with the bid further comprises a transaction that includes virtual currency.

15. The computing platform of claim 1, wherein the step of finalizing a transaction to attribute the item to a user associated with the bid further comprises presenting said user with the real-world item.

16. A computing platform providing a virtual world environment including an auctioning element being integrated into the virtual world environment, the computing platform comprising:
a processor;
a memory device communicatively coupled to the processor;
a user interface;
a virtual auction space component residing on a memory device and including instructions that when executed by the processor, are operative to:
generate data that represents a virtual auction;
create a visual environment for presentment of the auctioning data to the user interface;
receive a bid from the user interface for virtual item being auctioned as defined in the auction data;
present the bid to the virtual auction space by generating additional auction data representative of said bid;
generate additional auction data indicating that the bid from the user interface has been accepted as a winning bid for the virtual item being auctioned; and
finalize a transaction to attribute the virtual item to the user associated with the bid.

17. The computing platform of claim 16, wherein the step of creating a visual environment for presentment of the auctioning data to the user interface further comprises creating at least one avatar within the visual environment.

18. The computing platform of claim 16, wherein the step of finalizing a transaction to attribute the virtual item to the user associated with the winning bid further comprises the redemption of a voucher.

19. The computing platform of claim 16, wherein the step of finalizing a transaction to attribute the virtual item to the user associated with the winning bid further comprises a transaction that includes virtual currency.

20. A method for providing an auction element within a virtual world environment wherein the auction element is integrated with a real-world auction, the method comprising the steps of:
receiving auction data from a third party interface to said real-world auction;
creating a visual environment for presentment of the auctioning data to a user interface to said virtual world environment;
receiving a bid from a user interface for an item being auctioned as defined in the auction data;
presenting the bid to the real world auction through the third party interface;
receiving data from the third party interface indicating that the bid from the user interface has been accepted as a winning bid for the item being auctioned;
presenting to at least one user of the virtual world environment the said received data from the third party interface indicating that the bid from the user has been accepted; and
finalizing a transaction to attribute the item to a user associated with the winning bid.
